(19) United States
(12) Patent Application Publication
(10) Pub. No.: US 2010/0031048 A1
(43) Pub. Date: Feb. 4, 2010

(54) DATA AUTHENTICATOR

(76) Inventors: Jason David Koziol, Naperville, IL (US); Anthony Ryan Koziol, Gainesville, FL (US)

Correspondence Address: MANNAVA & KANG, P.C., 11240 WAPLES MILL ROAD, Suite 300, FAIRFAX, VA, 22030, US

(21) Appl. No.: 12/185,290

(22) Filed: Aug. 4, 2008

(51) Int. Cl. H04L 9/32

(52) U.S. Cl. 713/176

(57) ABSTRACT

A user encoded result is operable to be used to authenticate target data. The user encoded result is determined from a signature for the target data. The signature is formatted and encoded to create the user encoded result. The user encoded result is stored and is operable to be retrieved to authenticate the target data in response to the target data being accessed.

### BACKGROUND

Sensitive data, such as for example, email addresses, phone numbers, residence addresses, usernames, user passwords, bank accounts and/or credit card numbers are routinely stored on computer systems. Individuals often use personal computers to store sensitive data. Web servers frequently store personal data associated with different groups, such as for example, clients and customers. In many cases, such computer systems are communicatively coupled to the Internet, and the sensitive data is routinely exchanged between different computer systems via the Internet.

Connectivity to the Internet often exposes computers systems to malicious autonomous software applications or automated agents that “phish” for sensitive data. Phishing typically includes criminal or fraudulent attempts to acquire sensitive data from users by masquerading as a trusted entity. The malicious autonomous software applications or automated agents may generate emails, instant messages, or fake web sites masquerading as the user's bank or some other trusted entity in an attempt to solicit sensitive data from the user.

Measures have been taken to deal with the growing number of reported phishing incidents, which include legislation, increased public awareness, and some technical security measures. However, even given these measures, phishing still remains a huge problem, often leading to identity theft and other crimes.

### BRIEF DESCRIPTION OF DRAWINGS

The embodiments of the invention will be described in detail in the following description with reference to the following figures.

FIG. 1 illustrates a data authenticator system, according to an embodiment;

FIG. 2 illustrates encoding a user encoded result in the data authenticator system, according to an embodiment;

FIG. 3 illustrates decoding a user encoded result in the data authenticator system, according to an embodiment;

FIG. 4 illustrates examples of encoding and decoding, according to an embodiment;

FIG. 5 illustrates a method of generating a user encoded result, according to an embodiment;

FIG. 6 illustrates a method of generating a visible representation of a signature, according to an embodiment;

FIG. 7 illustrates a system, according to an embodiment; and

FIG. 8 illustrates a computer system that includes or hosts the data authenticator system, according to an embodiment.

### DETAILED DESCRIPTION

For simplicity and illustrative purposes, the principles of the embodiments of the invention are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the description of the embodiments.

According to an embodiment, a data authenticator system, also referred to as the data authenticator, enables a user to authenticate information. The information to be authenticated is referred to as target data. For example, the target data is a web site. A user may desire to authenticate the web site prior to sending confidential information to the web site. When the user first accesses the web site, the user creates a signature for the web site. The data authenticator determines a unique ID for the web site. The data authenticator encodes the unique ID of the web site and the signature to create a user encoded result (UER) for the web site. When the user returns to the web site, the data authenticator determines the unique ID, and identifies and decodes the UER for the web site. The result of the decoding is displayed to the user. If the displayed decoding result is a visual representation of the signature originally provided by the user for the web site, the user can quickly determine the web site is authentic. However, if the web site is a fake, such as a phishing web site created for malicious use, the displayed decoding result will not represent anything similar to the signature originally provided by the user for the web site.

According to an embodiment, the signature is formatted prior to creating the UER. The formatted signature is modified to include noise or modified in other manners to create a challenged representation of the signature. This challenged representation helps to prevent identifying and copying of the signature by a malicious agent. The formatted signature is then encoded using a unique ID for the target data or another key to create the UER.

In one embodiment, the data authenticator runs only on a client side of a network and is independent of the server. The data authenticator may be configured as a plug-in for a browser or an independent system working with data provided via a browser. The server or web site does not provide information used in the authentication process, which makes the data authenticator less susceptible to attacks typically performed on large consumer databases to illegally access large amounts of confidential data. For example, in this embodiment, neither a signature nor the UER is provided by the web site for output to the user. Thus, even if the web server is hacked, no authentication information can be illegally obtained for phishing.

In one embodiment, the data authenticator uses a signature created by the user, and the signature is not stored at the client or the server after it is used to created the UER. Thus, there is no way for a malicious agent to determine the signature provided by the user to attempt to provide a fake display representing authentication of the web site.

The data authenticator may be used to authenticate information and data other than web sites. The data authenticator may be used to authenticate information from a trusted source. For example, the data authenticator may be used to authenticate emails or instant messages from a trusted source. The data authenticator may be used to authenticate a word processing document, a pdf document or a spreadsheet. There may be other public information available to users that would be desirable to authenticate using the data authenticator before being used or accessed by a user.

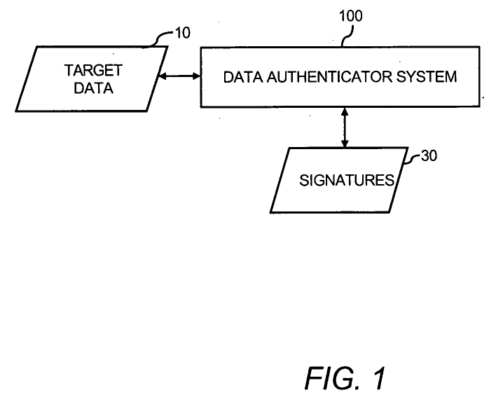

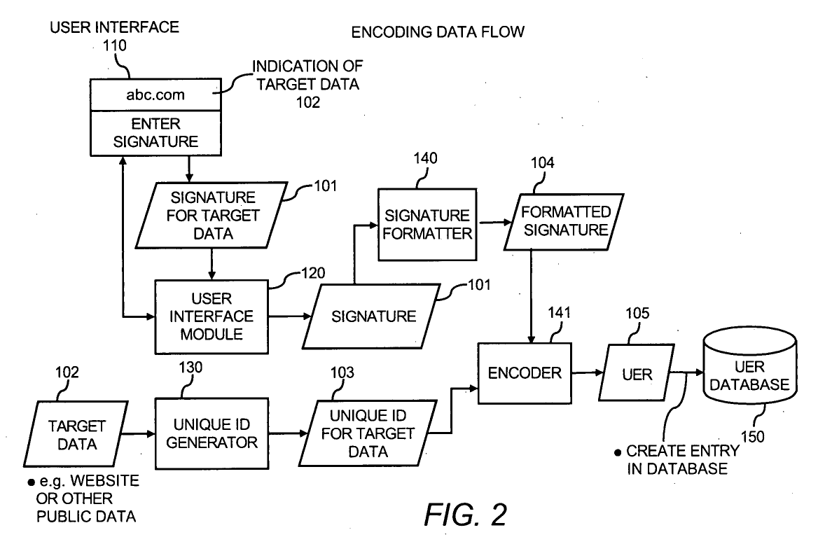

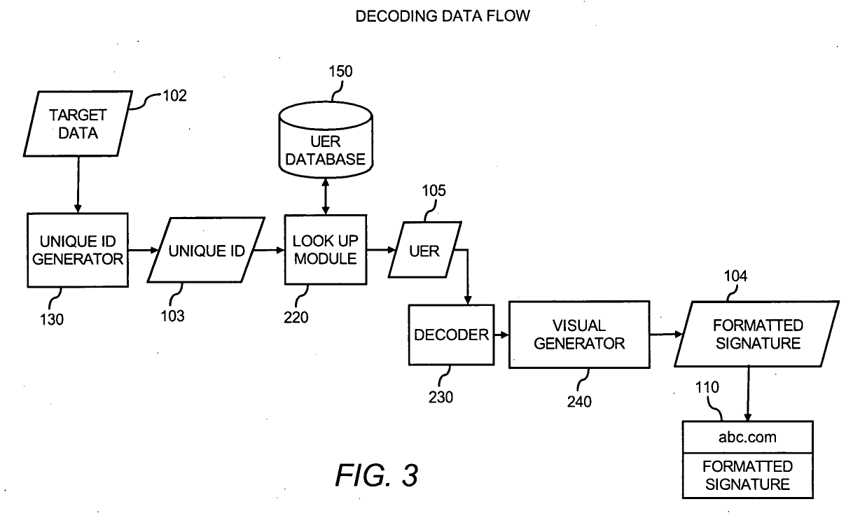

FIG. 1 shows a high-level block diagram of a data authenticator system 100 that is operable to be used to authenticate multiple target data 10 using signatures 30. A more detailed block diagram of the data authenticator is shown in FIGS. 2 and 3 and described in more detail below.

FIG. 2 shows a data flow for creating a UER, which is used to authenticate target data. FIG. 2 also shows components of the data authenticator system 100, according to an embodiment. The data authenticator system 100 includes a user interface module 120, a unique ID generator 130, a signature formatter 140, an encoder 141, and a UER database 150. Other components for the data authenticator system 100 are shown in FIG. 3.

The data authenticator system 100 is invoked so a signature can be provided for target data 102. This may include a user activating or launching the data authenticator system 100. The user interface module 120 receives a signature 101 for the target data 102. By way of example and not limitation, the target data 102 is a web site, abc.com. The user interface module 120 receives the signature 101 for abc.com via a user interface 110. For example, a user enters the signature 101 in the user interface 110, and the user interface module 120 receives or otherwise captures the signature 101.

In one example, the data authenticator system operates as a plug-in to a browser. A user indicates, for example, via a button or other graphical user interface on the browser that the user desires to authenticate the web site abc.com. A pop-up window is generated that allows the user to enter the signature 101. The user interface module 120 then receives the entered signature. The plug-in for a browser is one example of an implementation for the data authenticator system. It will be apparent to one of ordinary skill in the art that the data authenticator system can operate with many different applications to receive signatures for many types of target data and authenticate many types of target data. Furthermore, a signature can be generated from many different sources and is not limited to a user-entered signature. Also, a single signature may be used for one target data or many different target data.

A unique ID generator 130 generates unique IDs for target data. As shown in FIG. 2, the unique ID generator 130 generates unique ID 103 for the target data 102. For example, the unique ID 103 may be a URL for abc.com, an IP address or some other unique identifier of abc.com. In one example, the unique ID generator 130 captures the URL from the browser and uses the URL as the unique ID 103 or generates the unique ID 103 from the URL. For example, the URL is hashed to generate the unique ID. In one embodiment, the unique ID generator 130 and other components shown in FIGS. 2 and 3 are all on the client side. In another embodiment, the unique ID is provided from the server to the client. In this embodiment, the unique ID generator 130 is on the server. This provides additional protection against a hacker hacking the client to determine the function used by the unique ID generator 130 to generate the unique ID 103.

A signature formatter 140 and encoder 141 are used to create a UER 104 for the signature 101. The signature formatter 140 formats the signature 101 to create a formatted signature 104. The formatted signature 104 is a representation of the signature 101. In one embodiment, the formatted signature 104 is a challenged representation of the signature 101. The challenged representation poses an identification challenge for an automated agent to identify the signature in the challenged representation. This helps to prevent malicious agents from determining signatures for spoofing. An example of a challenged representation is shown in FIG. 3 and is described in more detail below. For example noise or other types of formatting are introduced into the signature to make it more difficult to identify. Known CAPTCHA generation techniques may be used to create the formatted signature 104. In other examples, multiple formats of the signature are sequentially displayed to create the challenged representation. U.S. patent application Ser. No. 11/612,470, entitled “Methods and Systems for Generating a Symbol Identification Challenge for an Automated Agent” and U.S. patent application Ser. No. 11/697,293, entitled “Methods and Systems for Generating A Single Identification Challenge” are both incorporated by reference in their entireties and describe different systems and methods for creating a challenged representation that may be used by the signature formatter 140.

The encoder 141 encodes the formatted signature 104, i.e., the challenged representation of the signature 101, to generate the UER 105. The UER 105 is stored in a UER database 150 and can be retrieved to authenticate the target data 102, when the target data is accessed in the future. The unique ID 103 may be stored along with the UER 105 in the UER database 150. The unique ID may be used as an index to retrieve the corresponding target data from the UER database 150.

According to an embodiment, the UER database 150 does not store the signatures that are used by the user to authenticate target data. Thus, if a malicious agent or unauthorized user somehow gets access to the UER database 150, they will not be able to identify any signatures that are used to authenticate sensitive data. It will be apparent to one of ordinary skill in the art that the UERs may be stored in data structures other than a database.

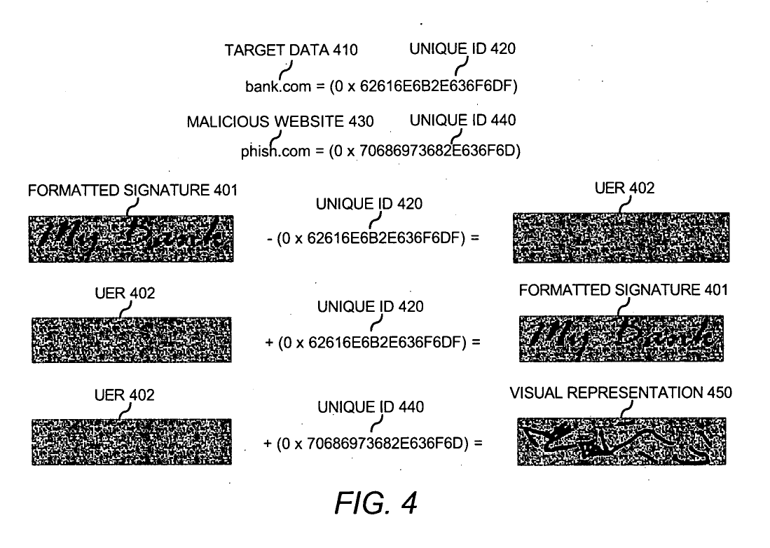

The encoder 141 may use the unique ID 103 to encode the formatted signature 104. In one example, the encoding process used by the encoder 141 to encode the formatted signature 104 may comprise a simple subtraction of the unique ID from the formatted signature. A decoding process may include adding the unique ID to the UER. This is illustrated in FIG. 4 and described below. In another example, a key is used to encode the formatted signature using a conventional encoding function. Other conventional encoding functions may be used.

The UER database 150 may be used to store many UERs and corresponding unique IDs for various target data. Then, when a specific target data is later accessed, the database 150 is queried for the corresponding UER, and the UER is decoded to generate the formatted signature. The formatted signature is then presented to the user to authenticate the data. The data flow for decoding a UER to generate the corresponding signature for authenticating target data is shown in FIG. 3, along with components of the data authenticator system for decoding UERs.

As shown in FIG. 3, the data authenticator system 100 includes, in addition to the components shown in FIG. 2, a lookup module 220 and a decoder 230 and a visual generator 240. The data flow shown in FIG. 3 is as follows. For example, the user accesses target data 102, such as abc.com, through a browser. The data authenticator system 100 is invoked to generate the signature for the target data 102 to authenticate the target data 102. In one example, a button or other graphical user interface may be presented to the user. If the button is activated, the data authenticator system 100 is invoked to generate the signature for authentication.

The unique ID generator 130 determines the unique ID 103 for the target data 102, such as described with respect to FIG. 2. The lookup module 220 uses the unique ID 103 to retrieve the corresponding UER 105 from the UER database 150. The decoder 130 decodes the UER 105 to generate the formatted signature 104. The formatted signature 104 is presented to the user via the user interface 110. In one embodiment, the visible generator 240 may be used to produce the formatted signature 104 and present the formatted signature 104 via the user interface 110, such as described in Ser. Nos. 11/612,470 and 11/697,293 incorporated by reference above.

The decoding process used by the decoder 230 corresponds to the encoding process used by the encoder 141. For example, the decoding process may include a subtraction of the unique ID from the UER if an addition was used for the encoding. In another example, a key is used to encode and decode the formatted signature using a conventional encoding function. The unique ID 103 may also be used by the decoder to decode the UER 105 to generate the formatted signature 104.

FIG. 4 illustrates examples of data used and generated by the data authenticator system 100, and FIG. 4 is described with respect to the components of the data authenticator system 100 shown in FIGS. 2 and 3. Target data 410 is bank.com in this example. The unique ID generator 130 determines unique ID 420 for the target data 410. The signature formatter 140 generates the formatted signature 401 shown for the target data 430. For example, the user enters a signature “My Bank” for bank.com. The signature formatter 140 creates a challenged representation of the signature shown as 401.

In this example, the encoding process includes a subtraction. For example, the encoder 141 encodes the formatted signature 401 by subtracting the unique ID 420 from the formatted signature 401 to generate the UER 402. For example, subtraction includes subtracting a value from an attribute of one or more of the pixels of the formatted signature 401. The attribute may include color in the range of 0 to 255 or some other pixel attribute. The value subtracted from the pixel attribute is determined from the unique ID. The value may be calculated such that it falls within a range of the pixel attribute, such as within the range of 0 to 255 for color. The decoding may include adding the value to the pixel attribute for the one or more pixels to derive the formatted signature 401 from the UER 402. More generally, the encoder 141 encodes the formatted signature as a function of the unique ID 420, and the encoding process is reversible. The encoding process may change the pixel attribute values so the original image (i.e., the formatted signature 401) is lost without the unique ID. In another example, which is described in U.S. patent application Ser. No. 11/697,293 and incorporated by reference above, the “polarization_angle2” is modified for all the frames rather than modifying every pixel in one or any frame. However, as described in the example above with respect to changing the color pixel attribute, pixel attribute values for one frame may be modified.

It should be noted that the signature or formatted signature 401 cannot be visual identified from the UER 402 by a user, if the UER 402 is presented to the user as shown. Thus, if the UER 402 is accessed by an unauthorized user or agent, they cannot present the UER 402 as the signature for data authentication. Thus, storing UERs rather than the signatures results in minimizing the risk of unauthorized users being able to determine signatures and use the signatures to fool users into submitting sensitive data to malicious or unauthorized agents or users.

Regarding the decoding process and using a stored signature to authenticate target data, the UER 402 is stored in the UER database 150. When, the user accesses bank.com again and the data authenticator system 100 is invoked (which may happen automatically or in response to user input), then the formatted signature 401 is presented to the user to authenticate bank.com. For example, the lookup module 220 retrieves the UER 402 from the UER database 150 using the unique ID 420. The decoder 230 decodes the UER 402 in this example by adding the unique ID 420 to the UER 402 to generate the formatted signature 401. The formatted signature 401 is presented to the user via the user interface 110. The user views the formatted signature 401 to determine whether it shows the signature that the user entered for bank.com. If the signature is shown, bank.com is authenticated, and the user may safely enter sensitive data in bank.com.

Now assume a malicious web site, phish.com, is attempting to spoof bank.com to get the user to send sensitive banking information to phish.com. Phish.com would need the UER 402, the unique ID 410 (or a key if a key was used for encoding and decoding), and the decoding process used by the decoder 230 to generate the signature. Assume, phish.com has the UER 402 and knows the decoding process. When the unique ID generator 130 generates the unique ID 440 for phish.com (shown as 430), the unique ID 440 is different than the unique ID 410. The result of the decoding using the incorrect unique ID 440 for the UER 402 would be visual representation 450. The user viewing the visual representation 450 could easily determine that the signature “My Bank” is not shown, and thus phish.com is not authenticated as bank.com. Then, the user would know not to enter any data into phish.com.

The formatted signature 401 represents an additional layer of security for the signature. By providing a challenge representation of the signature as the formatted signature, it is difficult for a malicious agent to copy the signature from the formatted signature.

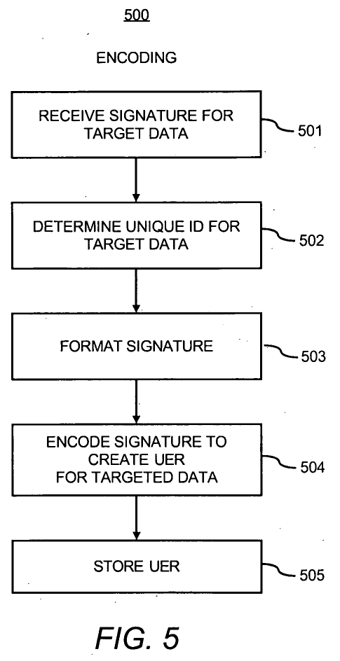

FIG. 5 illustrates a method for determining and storing a UER for target data, according to an embodiment. At step 501, a signature for target data is received. At step 502, a unique ID for the target data is determined. At step 503, the signature is formatted. At step 504, the formatted signature is encoded to generate a UER for the target data. The unique ID may be used to encode the formatted signature. At step 505, the UER is stored such that it can later be used to authenticate the target data.

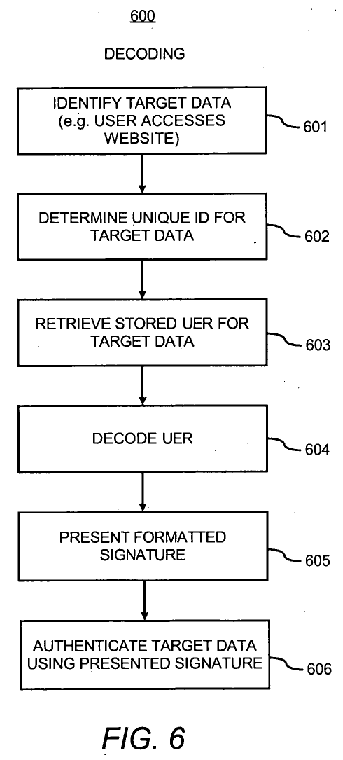

FIG. 6 illustrates a method 600 for authenticating target data using a UER for the target data, according to an embodiment. At step 601, the target data is identified. This may include invoking the data authenticator system 100 to present the signature for particular target data, such as when the target data is accessed. At step 602, the unique ID is determined for the target data. At step 603, the UER is retrieved from storage for the target data. The unique ID may be used to retrieve the target data. At step 604, the UER is decoded to generate the formatted signature for the target data. At step 605, the formatted data is presented to the user. At step 606, the user views the formatted signature to determine whether it shows the signature that was provided at step 501 in the method 500 for the target data. If the signature is shown, the target data is authenticated. If the signature is not shown, the target data is not authenticated.

The methods 500 and 600 include steps that are performed by the data authenticator system 100 shown in FIGS. 1-3. The methods 500 and 600 however may be implanted in other systems.

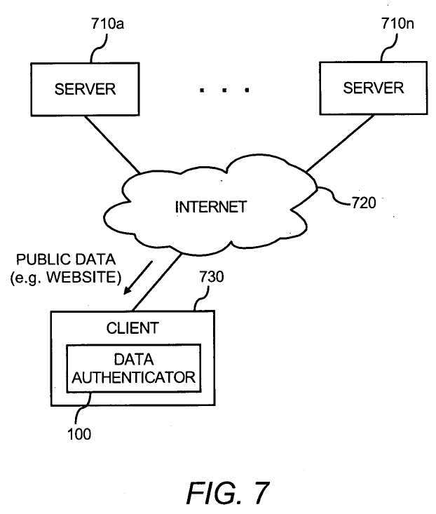

FIG. 7 shows a system 700 where the data authenticator system 100 is located on a client side. For example, the system 700 includes one or more clients, such as the client 730, that communicate with one or more servers 710a-n via a network 720, such as the Internet. A client, which may be a computer system, includes the data authenticator system 100. The data authenticator system 100 can be used to authenticate public data, such as web sites, accessed over the network 720. In this embodiment, the UER database storing the UERs is located only on the client side and the steps of the methods 500 and 600 are only performed on the client side. All or most of the components may be located on the client side. This provides an addition layer of protection, because authentication data, such as signatures, formatted signatures, keys, unique IDs and UERs, are not transmitted over the network 720. In other embodiments one or more of the components may be located on the server side. Also, one or more of the steps of the methods 500 and 600 may be performed on the server side.

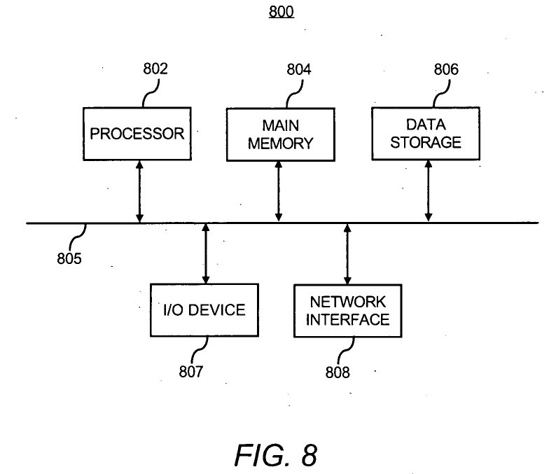

FIG. 8 illustrates an exemplary block diagram of a computer system 800 that may be used as or host the data authenticator system 100. The computer system 800 includes one or more processors, such as processor 802, providing an execution platform for executing software.

Commands and data from the processor 802 are communicated over a communication bus 805. The computer system 800 also includes a main memory 804, such as a Random Access Memory (RAM), where software may be resident during runtime, and data storage 806. The data storage 806 includes, for example, a hard disk drive and/or a removable storage drive, representing a floppy diskette drive, a magnetic tape drive, a compact disk drive, etc., or a nonvolatile memory where a copy of the software may be stored. The data storage 806 may also include ROM (read only memory), EPROM (erasable, programmable ROM), EEPROM (electrically erasable, programmable ROM).

A user interfaces with the computer system 800 with one or more I/O devices 808, such as a keyboard, a mouse, a stylus, display, and the like. The user interface 110 described above may include one or more I/O devices 808. A network interface 808 is provided for communicating with other computer systems via a network.

One or more of the components in the data authenticator system 100 may comprise software stored one or more computer readable mediums. Also, one or more of the steps of the methods described herein and other steps described herein may be implemented as software embedded on a computer readable medium, such as the memory and/or data storage, and executed on a computer system, for example, by a processor. The steps may be embodied by one or more computer programs comprised of program instructions in source code, object code, executable code or other formats for performing some of the steps. Any of the above may be embodied on a computer readable medium, which include storage devices. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes.

While the embodiments have been described with reference to examples, those skilled in the art will be able to make various modifications to the described embodiments without departing from the scope of the claimed embodiments.

What is claimed is:

1. A method of determining a user encoded result operable to be used to authenticate target data, the method comprising:
receiving a signature for target data stored on a remote computer;
determining a unique ID for the target data;
storing the unique ID at a local computer;
encoding the signature to create a user encoded result; and
storing the user encoded result at the local computer, wherein the stored user encoded result and the unique ID stored at the local computer are configured to be used to authenticate the target data.

2. The method of claim 1, wherein the user encoded result is only stored at the local computer.

3. The method of claim 1, wherein the user encoded result is stored at the local computer instead of the remote computer.

4. The method of claim 1, further comprising:
accessing the target data;
decoding the user encoded result associated with the target data; and
presenting the decoded user encoded result to authenticate the target data, wherein the presented user encoded result includes the signature for the target data if the target data is authentic.

5. A method of determining a user encoded result operable to be used to authenticate target data, the method comprising:
receiving a signature for target data;
formatting the signature;
encoding the formatted signature to create a user encoded result; and
storing the user encoded result, wherein the stored user encoded result is configured to be used to authenticate the target data.

6. The method of claim 5, wherein the formatted signature is a representation of the signature that poses a challenge for an automated agent to identify the signature.

7. The method of claim 6, wherein formatting the signature comprises including noise in a visual representation of the signature, wherein the noise poses a challenge to identify the original signature.

8. The method of claim 5, wherein encoding the formatted signature to create a user encoded result comprises:
using a key to encode the signature, wherein the key comprises at least a portion of the signature or at least a portion of a unique ID for the target data.

9. The method of claim 5, further comprising:
determining a unique ID for the target data; and
storing the unique ID such that the unique ID is associated with the user encoded result for the target data.

10. The method of claim 9, further comprising:
storing a plurality of user encoded results and a unique ID for each user encoded result, wherein each user encoded result is generated for a particular target data; and
retrieving a stored user encoded result for one of the particular target data in response to that target data being accessed;
decoding the stored user encoded result to determine a formatted signature from the stored user encoded result; and
presenting the formatted signature to authenticate the particular target data.

11. The method of claim 10, wherein presenting the formatted signature comprises presenting the formatted signature in a user interface, wherein a user is operable to view the formatted signature to determine whether a signature originally provided for the target data is identifiable from the formatted signature.

12. At least one computer readable medium storing at least one computer program including instructions that when executed on a computer perform a method of determining a user encoded result operable to be used to authenticate target data, the method comprising:
receiving a signature for target data;
formatting the signature;
encoding the formatted signature to create a user encoded result; and
storing the user encoded result, wherein the stored user encoded result is configured to be used to authenticate the target data.

13. The at least one computer readable medium of claim 12, wherein the user encoded result is only stored at the local computer.

14. The at least one computer readable medium of claim 12, wherein the user encoded result is stored at the local computer instead of the remote computer.

15. The at least one computer readable medium of claim 12, wherein the formatted signature is a representation of the signature that poses a challenge for an automated agent to identify the signature.

16. The at least one computer readable medium of claim 12, wherein encoding the formatted signature to create a user encoded result comprises:
using a key to encode the signature, wherein the key comprises at least a portion of the signature or at least a portion of a unique ID for the target data.

17. The at least one computer readable medium of claim 12, wherein the method further comprises:
storing a plurality of user encoded results and a unique ID for each user encoded result, wherein each user encoded result is generated for a particular target data; and
retrieving a stored user encoded result for one of the particular target data in response to that target data being accessed;
decoding the stored user encoded result to determine a formatted signature from the stored user encoded result; and
presenting the formatted signature to authenticate the particular target data.

18. The at least one computer readable medium of claim 17, wherein presenting the formatted signature comprises presenting the formatted signature in a user interface, wherein a user is operable to view the formatted signature to determine whether a signature originally provided for the target data is identifiable from the formatted signature.

19. A computer system configured for authenticating target data, the computer system comprising:
data storage storing user encoded results and a unique ID for each user encoded result; and
a processor configured to determine the user encoded results and the unique ID for each user encoded result, wherein each user encoded result is determined for a specific target data and is generated from a signature provided for the specific target data, and
the processor is configured to provide a representation of a signature from a stored user encoded result to authenticate a specific target data corresponding to the stored user encoded result.

20. The computer system of claim 19, further comprising:
a user interface configured to present the representation of the signature to a user to a user to authenticate the specific target data, wherein the representation of the signature poses a challenge for an automated agent to identify the signature.
